(19) United States
(12) Patent Application Publication
(10) Pub. No.: US 2025/0115447 A1
(43) Pub. Date: Apr. 10, 2025

(54) TRANSPORTING A SHEET THROUGH A PLASMA TREATMENT UNIT

(71) Applicant: Canon Production Printing Holding B.V., Venlo (NL)

(72) Inventors: Guido G. WILLEMS, Venlo (NL); Hermanus M. KUYPERS, Venlo (NL); Sandor H.G. JOPPEN, Venlo (NL)

(73) Assignee: Canon Production Printing Holding B.V., Venlo (NL)

(21) Appl. No.: 18/903,662

(22) Filed: Oct. 1, 2024

(30) Foreign Application Priority Data
Oct. 9, 2023 (EP) 23202493.5

(51) Int. Cl. B65H 5/22; B41J 2/21; B41J 11/00; B65H 9/10

(52) U.S. Cl. CPC B65H 5/222; B41J 2/2114; B41J 11/0045; B65H 9/105

(57) ABSTRACT

A plasma treatment unit for a printer includes a gap directly upstream of its electrode. A sheet may bend into the gap, resulting in damage to the sheet or paper jams. The risk of this is reduced or prevented by a method for transporting sheets of print media between electrodes of a plasma treatment unit of a printer, including arranging the sheet and the electrodes, so that an edge of the sheet and an upstream edge of at least one of the electrodes are at a non-zero angle with one another, as the sheet passes over the electrode.

### BACKGROUND OF THE INVENTION

### 1. Field of the Invention

The invention relates to a method for transporting sheets of print media between electrodes of a plasma treatment unit of a printer and to such a printer.

### 2. Description of Background Art

Plasma treatment, as known from e.g. EP2802455 B1, EP3344458 B1, and/or EP2988945 B1, may be used to adjust the surface properties of a sheet, so that the application of a liquid, such as primer or printing ink, thereon is improved. Specifically, the interaction between a primer and subsequently applied printing ink can be improved, e.g. to improve coalescence behavior of the printing ink on a layer of primer. The plasma treatment is performed prior to applying said liquid on the sheet. Such a printer comprises a plasma treatment unit, which comprises a pair of spaced apart electrodes for generating a plasma between them and a transport mechanism. The transport mechanism comprises a support structure spaced apart from one of the electrodes by a gap and a drive for transporting the sheet in a transport direction over the support structure, over the gap, and over the one of the electrodes. The gap is provided to electrically isolate the high voltage electrodes from the support structure, but also forms a free space wherein in the sheet can become temporarily trapped. The sheet may bend into the gap under the influence of gravity and/or a negative pressure applied for holding the sheet flat on the support structure, which could result in folds or wrinkles in the sheet, or even paper jams in the printer.

### SUMMARY OF THE INVENTION

It is an object of the invention to provide an improved method of passing sheets of print media through a plasma treatment unit of a printer, preferably a more reliable method.

In accordance with the present invention, a method for transporting sheets of print media between electrodes of a plasma treatment unit of a printer according to claim 1 and a printer according to claim 11 are provided. The printer comprises comprising a support structure spaced apart from one of the electrodes by a gap.

The method comprises the step of:
transporting the sheet towards the electrodes, so that a forward facing edge of the sheet and an upstream edge of at least one of the electrodes are at a angle greater than 5° with one another, as the sheet passes over said electrode and over a gap at least partially formed by an edge of said electrode.

The gap extends parallel to the upstream edge of the respective electrode. As the sheet's edge is at an angle with said upstream edge, it is at an angle with the gap. The sheet then moves over the gap, initially with only a relatively small or narrow portion, for example a corner of the sheet. Due to the relatively small or narrow width of the said portion in the lateral direction as compared to its length in the transport direction, the portion is relatively stiff or rigid, which reduces or prevents it from curving downwards into the gap due to e.g. gravity and/or suction applied to the portion at and/or around the gap. The angle is a non-zero angle, which preferably also positions the center of mass of the portion over the gap relatively close to the upstream edge of the gap. Relatively is herein with reference to the situation wherein the sheet would pass over the electrode and the gap with its leading edge parallel to the edge of the electrode. As the gap is relatively narrow, only a small portion of the sheet needs to pass reliably over the gap before the leading portion of the sheet becomes also supported on an electrode. Thus, the reliability of sheets passing through the plasma treatment unit is improved. Thereby the object of the present invention has been achieved.

More specific optional features of the invention are indicated in the dependent claims.

In an embodiment, the method further comprises the step of applying a negative pressure to a surface of the sheet facing the gap for drawing the sheet against a support structure which together with the edge of the one of the electrodes forms the gap. To pass the sheet flatly between the electrodes, a negative pressure is applied to one side of the sheet. This draws the sheet flat against the support structure and optionally also against one of the electrodes. The negative pressure may be applied in the form of suction, which also causes the sheet to be drawn into the gap. This would increase the risk of the leading edge of the sheet from becoming trapped in the gap, which risk is eliminated and/or reduced herein by the sheet being at a non-zero angle with respect to the edge of the electrode.

In an embodiment, the method comprises the step of transporting the sheet between the electrodes in a transport direction, so that a width in a lateral direction of a portion of the sheet over the upstream edge of the at least one of the electrodes increases from at least when the sheet initially moves over said upstream edge. Initially the width of the portion of the sheet over the gap increases as the sheet begins to cross over the gap. Preferably the increase is gradual. In consequence, the first portion of the sheet to extend over the gap is narrow, giving it a relatively high stiffness. Preferably, the center of mass of the portion is initially also upstream of a central point in the gap in the transport direction. As the sheet moves forward across the gap, the width of the portion over the gap increases. The gap is preferably sufficiently narrow, so that its leading portion is supported on the bottom electrode before a maximum width of the sheet is over the gap.

In an embodiment, the method further comprises the step of applying a liquid on the treated sheet. The plasma treatment adjusts the surface free energy of the sheet, at least on one side of it, so that a surface of the sheet is prepared for reliable adherence of the liquid. In another embodiment, a coating liquid is applied directly on the treated sheet, followed by the application of color inks on the coating liquid, preferably wherein the coating liquid is a primer liquid. The liquid is preferably a colorless or transparent primer, which is to cover the to be printed area of the sheet substantially fully. The primer ensures a reliable adherence to and/or improved coalescence of the color inks on the primer layer, which are to be printed on the layer of primer. It will be appreciated that the plasma treatment may alternatively be applied to prepare the sheet surface for direct adhesion of the color inks, without a layer of primer in between. Color inks may be any commercially available inkjet ink.

In an embodiment, the method further comprises the step of re-orienting the treated sheet, so that one of its edges is substantially parallel to a lateral direction perpendicular to a transport direction of the sheet. At certain positions in the printer, the sheet is preferably oriented with its leading edge perpendicular to the transport direction. Examples are e.g. at an output location when forming a sheet stack, at the print assembly so that the leading edge is parallel to the printhead array, at a turn station for flipping the sheet, etc. Thereto, the sheet is in one or more places is re-aligned so that its leading edge is substantially parallel to the lateral direction.

In an embodiment, the step of arranging comprises rotating the sheet upstream of the treatment unit, so that one of its edges is at a non-zero angle with the lateral direction.

The sheet moves through certain sections of the printer with its leading edge substantially perpendicular to the transport direction. Upstream of the treatment unit, the sheet is rotated out of this latter orientation, so that its previously leading edge is at a non-zero angle with the gap and the upstream edge of the bottom electrode.

In an embodiment, a substantially empty gap is positioned at the upstream edge of the at least one of the electrodes, and the method further comprises a portion of the sheet first passing over the gap before reaching said electrode. The gap forms an empty space directly upstream of the bottom electrode. The sheet has to traverse the gap to enter in between the electrodes. The gap is preferably narrow, equidistant, and/or parallel to said edge of the bottom electrode. Since the sheet is thus skewed with respect to the gap, only a relatively narrow portion of the sheet moves first over the gap, thereby allowing it to pass safely over the gap.

A further aspect of the invention relates to a printer comprising a plasma treatment unit with:
a pair of spaced apart electrodes for generating a plasma between them; and
a transport mechanism comprising:
   a support structure spaced apart from one of the electrodes by a gap;
   a suction arrangement for applying a negative pressure for drawing a sheet against at least the support structure; and
   a drive for transporting the sheet in a transport direction over the support structure, over the gap, and over the one of the electrodes,
wherein the printer is configured, so that the drive transports the sheet over the one of the electrodes, and preferably over the gap, at a non-zero angle greater than 5° of a forward facing edge of the sheet with respect to an upstream edge of the one of the electrodes. The suction arrangement applies the negative pressure to the sheet, drawing it against the support structure and/or the one electrode. This results in a force on the sheet which could draw the leading edge into the gap, causing it to become stuck or damaged. As described above, the non-zero angle results in the sheet passing over the gap first with only a relatively narrow portion. This narrow portion has a relatively high stiffness or rigidity, so that it is able to move across the gap without bending into the gap under the influence of gravity. This results in reliable sheet transport through the plasma treatment unit.

In an embodiment, the printer further comprises at least one registration drive of a registration unit for adjusting an orientation of the sheet with respect to the transport direction, wherein the at least one registration drive is configured for:
orienting the sheet, so that its forward facing edge is at the non-zero angle with respect to the upstream edge of the one of the electrodes when passing between the electrodes; and
orienting the sheet, so that its forward facing edge is substantially perpendicular to the transport direction.

The printer comprises one or more registration drives which can change the angle between a forward facing edge of the sheet and the lateral direction from substantially zero to non-zero and/or vice versa. A registration drive can be applied to rotate the sheet so that its leading edge is perpendicular to the transport direction, for example when the sheet passes the printhead assembly or arrives at the output location. The same or a different registration drive can be applied to rotate the sheet, so that its edges are all at a skewed angle with the gap. In another embodiment, orienting the sheet, so that its leading edge is substantially perpendicular to the transport direction, is performed:
upstream of a printing assembly, so that the leading edge of the sheet is substantially parallel to a direction wherein the printing assembly extends; and/or
upstream of an output location, so that the sheet is positioned at the output location with its leading edge substantially perpendicular to the transport direction.

In another embodiment, the upstream edge of the one of the electrodes is substantially perpendicular to the transport direction, and at least one registration drive of a registration unit is configured to re-orient the sheet, so that its forward facing edge is at the non-zero angle with respect to the upstream edge of the one of the electrodes when passing between the electrodes.

In an embodiment, the upstream edge of the one of the electrodes is positioned substantially at a non-zero angle with respect to a lateral direction perpendicular to the transport direction, so that a forward facing edge of the sheet when parallel to the lateral direction passes over said upstream edge substantially at an angle therewith. The sheet may also pass the gap with its leading edge substantially perpendicular to the transport direction if the gap and the edge of the electrode are inclined with respect to the lateral direction. The electrode's edge may be positioned skewed with respect to the transport direction. The electrode's edge may also be curved, smoothly or irregular, so that portions of the edge are inclined with respect to the lateral direction. The gap therein preferably follows the curvature of the edge. Preferably, the registration unit is configured to orient the leading edge of the sheet, so that it is substantially parallel to the lateral direction as it passes over the electrode. Thereby, the sheet is at the non-zero angle with respect to the edge. This orientation of the sheet corresponds to the orientation wherein the sheet passes the printhead assembly.

Further scope of applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a schematic side view of a representation of a sheet printer;

FIGS. 2 to 7 are a schematic top views different steps of transporting a sheet through a first embodiment of a plasma treatment unit for use in the printer in FIG. 1;

FIG. 8 is a schematic side view of a first embodiment of a plasma treatment unit for use in the sheet printer in FIG. 1;

FIG. 9 is a schematic side view of a second embodiment of plasma treatment unit for use in the sheet printer in FIG. 1; and

FIG. 10 is a schematic side view of a third embodiment of plasma treatment unit for use in the sheet printer in FIG. 1.

### DETAILED DESCRIPTION OF THE PREFERRED EMBODIMENTS

The present invention will now be described with reference to the accompanying drawings, wherein the same reference numerals have been used to identify the same or similar elements throughout the several views.

### Sheet Printer

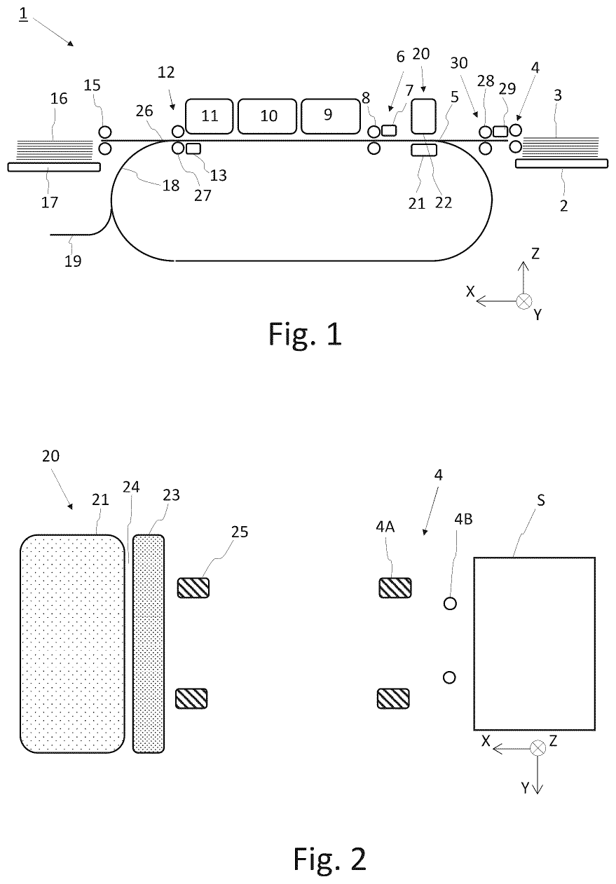

FIG. 1 illustrates a sheet printer 1. An input module 4 on the right side comprises one or more input stack supports 2 supporting at least one stack 3 of sheets. Individual sheets are separated from the stack 3 by the input module 4, which places the sheets on an input path of the printer 1. The input module 4 may comprise a separator to separate individual sheets from the stack 3. The input module 4 is further provided with a first registration unit 30 comprising a first registration drive 28 to adjust the position and/or orientation of the sheet. The adjustment may be done based on a sheet detection by means of the first sheet detector 29, which may measure the position and/or orientation of a sheet. Alternatively, the position and/or orientation of a sheet may be deduced from its location on the stack support 2. The input path brings the sheets to a print path section, illustrated as a straight, linear path, where the sheet is processed for printing thereon. The print path section comprises a switch 5 positioned at an intersection of the input path and a duplex path, which duplex path is arranged to return printed sheets to the print path. Sheets on the print path can thus be a mix of unprinted or one-side printed sheets.

The sheet then passes through a treatment unit 20, which treats the surface of the sheet to alter its surface properties, such as its surface free energy. The surface of the sheet is adjusted to achieve a desired wetting behavior of the liquids to be jetted on its surface. The treatment unit 20 is preferably a plasma treatment unit, specifically a corona treatment unit. In FIG. the treatment unit 20 comprises a first and second electrode 21, 22 positioned on opposite sides of the print path in the vertical direction Z. A high voltage is applied between the electrodes 21, 22 to generate a plasma, specifically a corona, between them. As the sheet passes in between the electrodes 21, 22, its free or top surface is exposed to the plasma, thereby altering its surface free energy. Such a plasma treatment device is known from e.g. EP2802455 B1, EP3344458 B1, and/or EP2988945 B1, the contents of which are herein incorporated by reference.

The print path comprises a second registration unit 6 downstream of the treatment unit 20. The second registration unit 6 comprises a second sheet detector 5 for detecting a position and orientation of each sheet. The orientation of the sheet is e.g. the angle of its forward facing or leading edge with respect to the transport direction X. Dependent on the measured position and orientation, the second registration unit 6 controls its registration drive 7 to position the sheet to a predefined position and/or align the sheet to a predefined orientation, for example with its leading edge perpendicular to the transport direction X, so that it will be parallel to the printhead assembly 10.

The registered sheet subsequently passes by a coater 9, which applies a liquid coating on at least a portion of the treated surface. The coater 9 may for example comprise an array of printheads configured to jet droplets of coating liquid or comprise a roller for transferring coating liquid as the roller rolls over the sheet. Any suitable coating liquid may be applied, such as for example Canon ColorGrip. The coating liquid preferably forms a continuous coat on the sheet, which enables or improves the bonding of color inks to the sheet.

The coated sheets travels to the printhead assembly 10, which jets one or more layers of color inks onto the coated sheet. The printhead assembly 10 is preferably a page wide array of inkjet printheads to allow productive printing.

The jetted color inks are then fixed onto the sheet by means of a fixation unit 11. The fixation unit 11 applies or removes energy from the sheet, so that the jetted color inks undergo a phase change. The fixation unit 11 may comprise coolers and/or heaters, such radiation heaters with e.g. UV or IR light, hot air blowers, such as impingement blowers, contact heaters, such a heated transport belt or drum, etc. Alternatively or additionally, the fixation unit 11 may comprise curing station, which emits light with a wavelength which induces a chemical reaction in the color inks and/or coating liquid, causing these to solidify.

At the downstream side of the print path, a third registration unit 12 is provided to adjust the position and/or orientation of the sheets. This third registration unit 12 may be configured similar to the second registration unit 6. The third registration unit 12 can be applied to position and/or orientation a sheet with respect to a specific output location, for example a stacking location or a finisher, such as a cutter or book binder. The third registration unit 12 comprises its own registration drive 27 and may comprise a sheet detector 13, or the sheet position can be derived by tracking the sheet's movement after detection by the second sheet detector 7.

At the end of the print path, a further switch 26 is provided to selectively direct sheets into the duplex path or to the output location. The duplex path preferably comprises a turn station, which inverts the sheet, so that it leaves the duplex path with its unprinted side eventually facing the printhead assembly 10. The output location in FIG. 1 comprises a stacker 15, which gathers the printed sheets in a further stack 16 on a further stack support 17. As previously indicated other suitable output devices, such as finishers may be provided at the output location.

### Sheet Transport in the Treatment Unit

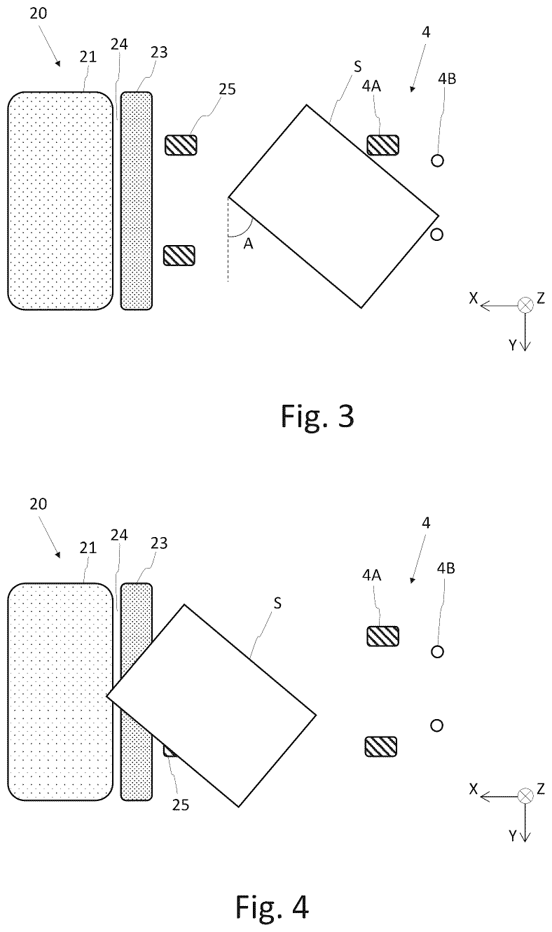

FIG. 2 illustrates the step of transporting a sheet S on the input path. The sheet S has substantially the same orientation as it has in the stack 3, with its leading edge perpendicular to the transport direction X. The sheet S moves over the first sheet detector 28. The first sheet detector 29 is illustrated here as two laterally spaced apart photo-diodes, which allow the angle of the leading edge of the sheet with respect to them to be deduced from the time differences between the signals from the photo-diodes. Other suitable detectors such as cameras or scanners may be applied as well. Additionally, the first sheet detector 29 may be configured to further detect the sheet position, for example by detecting one or more points along one of its lateral edges. As previously indicated, the first sheet detector 29 may be omitted if the position and orientation of the sheet S can be deduced from its starting position on the stack support 2.

The detected orientation of the sheet is compared to a predetermined orientation, and based on that, the first registration drive 28 is controlled to adjust the orientation of the sheet S. The first registration drive 28 comprises two independently drivable rollers, so that by applying different speeds, the sheet S can be re-oriented and/or shifted. Different registration drives, such as sliders or shifters may be applied as well.

As shown in FIG. 3, the sheet S is re-oriented by the first registration drive 28 in a predetermined orientation, where its edges are skewed or inclined with respect to the lateral direction Y and/or the transport direction X. The lateral direction Y is perpendicular to the transport direction X and preferably parallel to the printhead assembly 10. The edge of the sheet S, which in FIG. 2 was the leading edge, has been titled into a non-zero angle A with respect to the lateral direction Y. While in FIG. 2, the angle A was substantially zero, in FIG. 3 the sheet S has been rotated so that the angle A is visibly different from zero. Preferably the sheet S is sufficiently rotated, so that the angle A is greater than 10°, preferably greater than 20°, very preferably greater than 30°. Consequently, the leading edge of the sheet S is at a non-right angle with the transport direction X. One of the corners of the sheet S then protrudes in the transport direction X and is positioned ahead of the other corners in the transport direction X. Preferably, the distance between the forward corner and any trailing corner in the transport direction X is at least several centimeters, preferably more than 3 cm, even more preferably more than 5 cm.

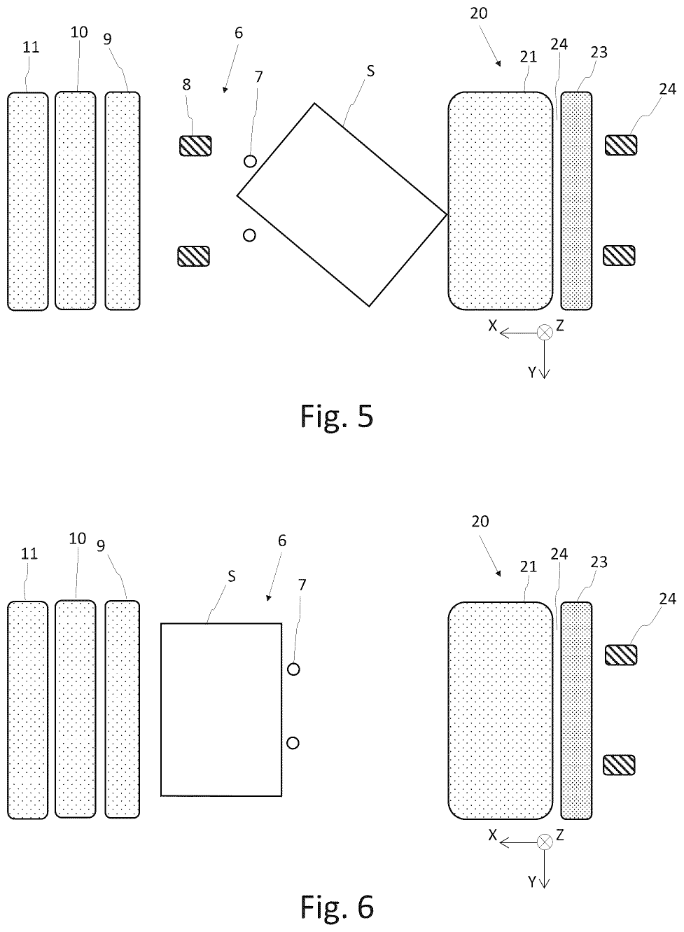

The sheet S arrives in its rotated state at the treatment unit 20 in FIG. 4. As can be seen also in FIG. 8, the treatment unit 20 comprises a transport mechanism, which comprises a drive in the form of pinch rollers 25 and a support structure 23. The support structure 23 is positioned on the bottom side of the print path to support the sheet S and prevent it from bending downwards under the influence of gravity. The support structure 23 may comprise a plate or beams to support the sheet S. The pinch rollers 25 are driven rollers which push the sheet S over the support structure 23 towards the electrodes 21, 22. Due to the high voltage on the electrodes 21, 22, the support structure 23 is spaced apart from the bottom electrode 21, resulting in the gap 24. The gap 24 forms a vacant opening between the bottom electrode 21 and the support structure 23. A suction arrangement 35 is provided to hold the sheet S flat as it passes through the treatment unit 20. The suction arrangement 35 comprises a suction source 36, such as a pump or fan, which applies a negative pressure in the suction chamber 39. The suction chamber 39 connects the suction source 36 to suction openings 37, 38 in the support structure 23 and/or the bottom electrode 21. The support structure 23 may e.g. comprise a support plate or parallel support beams. In FIG. 8, the suction chamber 39 is also connected to the gap 24, so that a negative pressure is applied therein. The negative pressure ensures that the sheet S passes flatly between the electrodes 21, 22. It will be appreciated that the suction chamber 39 may be configured differently, so that e.g. separate suction chambers are provided for the electrode 21 and the support structure 23, respectively. Alternatively only the bottom electrode 21 or the support structure 23 may be provided with suction openings 37, 38. The distance across the gap 24 in the transport direction X is relatively large, as compared to the cross-section of a suction opening 37, 38. The negative pressure present in and around the gap 24 in combination with gravity may pull the leading edge of the sheet S into the gap 24. This is however prevented by the rotated orientation of the sheet S, such that the sheet S tapers towards the gap 24 as it approaches the gap 24. It will be appreciated that the negative pressure is selected, so that the sheet able to slide across the support structure 23 and/or the bottom electrode 21.

The sheet S passes over the support structure 23 under the non-zero angle A, such that the forward corner of the sheet S first passes over the gap 24. As the sheet S moves further in the transport direction, the width of its portion over the gap 24 increases, at least until a second corner of the sheet S passes the gap 24. Due to the relatively large angle A, the sheet at the forward corner is relatively narrow as it passes over the gap 24. The portion of the sheet S overhanging the gap 24 is then relatively stiff or rigid, preventing it from bending into the gap due to the applied negative pressure and/or gravity. Since the rotated sheet S tapers in the transport direction X, it is able to pass over the gap 24 without folding or bending. The sheet S thus passes reliably over the gap 24 in between the electrodes 21, 22.

The skewed sheet S then passes over the bottom electrode 21, so that is top surface is exposed to the plasma between the electrodes 21, 22. Thereby, the surface energy of the sheet S is adjusted to a desired range corresponding to a coating liquid that is applied by the coater 9. The changed surface energy of the sheet S ensures a reliable adhesion of the coating liquid on the sheet S.

Before reaching the coater 9, the treated sheet 9 passes over the second registration unit 6 in a skewed state, as shown in FIG. 5. FIG. 6 illustrates the second registration unit 6 re-orienting the sheet S, so that its leading edge is substantially parallel to the lateral direction Y. This allows the image to be printed without digitally correcting for the angle A. Before printing the image, the registered sheet S is provided with a layer of coating liquid by the coater 9. It will be appreciated that the second registration unit 6 may in a further embodiment be provided between the coater 9 and the printhead assembly 10. In another embodiment, the second registration unit 6 may be omitted and the digital image is adjusted to incorporate the angle A, so that the image is printed correctly aligned on the skewed sheet S.

The registered and coated sheet S then is transported past the printhead assembly 1, which prints an image on the sheet S. Both the coater 9 and the printhead assembly 10 preferably comprise printheads configured to jet liquid droplets of respectively color ink or coating liquid onto the sheet S. The color ink(s) or coating liquid are then fixed on the sheet S by the fixation unit 11, which for example heats the sheet S by blowing heated air onto it. Thus, a robustly printed sheet S is achieved, as shown in FIG. 7.

At the end of the print path, the sheet S passes over the third registration unit 12. Dependent on the subsequent destination, the sheet S may be re-oriented and/or positioned. In case, the print job for a sheet S has been entirely completed, the sheet S is passed to the output location via the further switch 26. The third registration unit 12 may then move the sheet S corresponding to an output position, for example a stacker or finisher. In case, the sheet S requires further printing, for example in the case of duplex printing, the sheet S is directed into the duplex path. The sheet S may then again be re-oriented into a skewed state wherein one of its edges is at an angle A with the lateral direction Y using the third registration drive 27. Thus, the sheet S is then in an orientation so that it will safely pass over the gap 24, when it returns for printing on its unprinted side. It will be appreciated that the number and/or positions of the registration units may be varied in any manner, as long as the sheet arrives at the treatment unit with a skewed angle with respect to the upstream edge of the electrode.

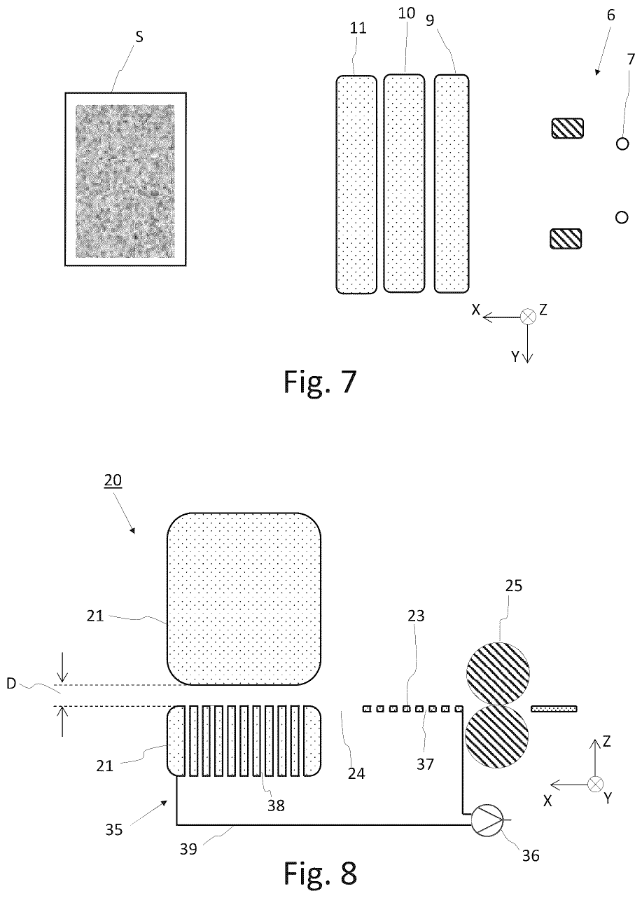

FIG. 9 illustrates a further embodiment of a treatment unit 120, wherein the sheet S passes over the gap 124 with an edge at an angle B with the gap 24. The bottom electrode 21 has been arranged, so that its upstream edge is at an angle B with the lateral direction Y. This may e.g. be performed by mounting the electrodes 21, 22 skewed in the printer 1 with respect to the transport direction X. Similarly, the support structure 23 defines a downstream edge facing the bottom electrode 21, which edge is at a similar angle B with respect to the lateral direction Y. In consequence, an equidistant gap 124 is formed which extend under an angle B with the lateral direction Y. The leading edge of the sheet S will thus gradually pass over the gap 124 when the leading edge is substantially parallel to the lateral direction Y. First only a corner of the sheet S passes over the gap 124, followed by an increasing width of the sheet S in the lateral direction Y passing over the gap 124 at least until a second corner of the sheet S moves over the gap 124. As the corner is relatively stiff, this allows the sheet S to safely move over the gap 124.

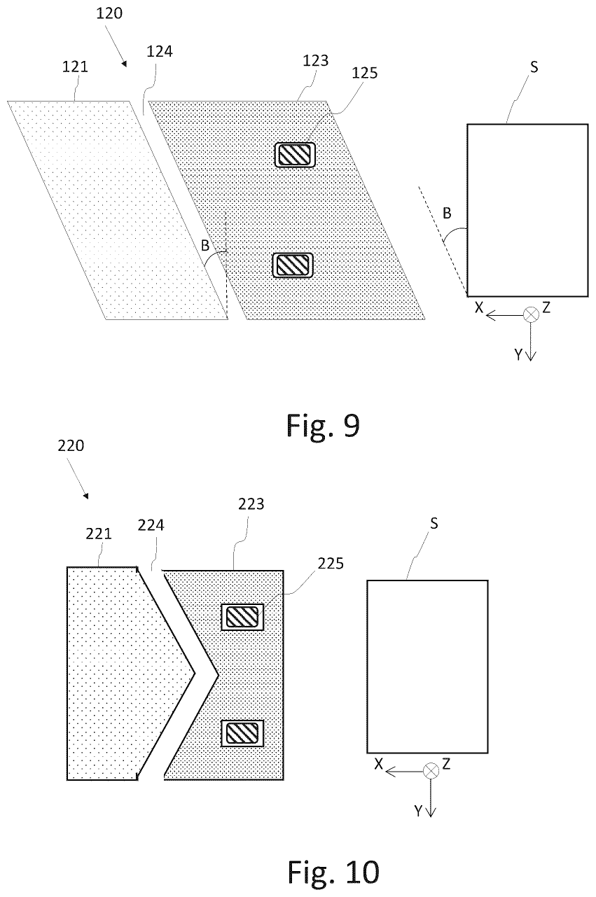

FIG. 10 illustrates another embodiment, wherein the bottom electrode 221 is shaped, so that an edge of the sheet S passes over it at a substantially non-zero angle. The upstream edge of the electrode 221 is curved or angled, so that it defines a varying angle with the lateral direction Y along said direction Y. The edge of the sheet S, as in FIG. 9, thus substantially always are at an angle with the opposing edges of the gap 224. In FIG. 10, two corners of the sheet S can pass simultaneously over the gap 224 if the sheet's leading edge is parallel to the lateral direction Y. A portion of the leading edge in between corners of the sheet S first passes over the gap 124. Therein, the relatively high stiffness is achieved by this portion being supported on both sides by portions of the sheet still on the support structure 223. It will be appreciated that the curvature of the gap 124 may in another embodiment be inverted, so that two corners with relatively high stiffness passed first over the gap. The curvature may also be smoothly changing across the lateral direction Y, so that the edge forms a curved arch.

Although specific embodiments of the invention are illustrated and described herein, it will be appreciated by those of ordinary skill in the art that a variety of alternate and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, “third”, etc. are used merely as labels, and are not intended to impose numerical requirements on or to establish a certain ranking of importance of their objects.

The present invention being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for transporting sheets of print media between electrodes of a plasma treatment unit of a printer, comprising a support structure spaced apart from one of the electrodes by a gap, wherein the method comprises the step of:
transporting the sheet towards the electrodes, so that a forward facing edge of the sheet and an upstream edge of at least one of the electrodes are at an angle greater than 5° with one another, as the sheet passes over said at least one electrode and the gap at least partially formed by an edge of said at least one electrode.

2. The method according to claim 1, further comprising the step of applying a negative pressure to a surface of the sheet facing the gap for drawing the sheet against the support structure, which together with the edge of one of the electrodes forms the gap.

3. The method according to claim 1, further comprising the step of transporting the sheet between the electrodes in a transport direction, so that a width in a lateral direction of a portion of the sheet over the upstream edge of the at least one of the electrodes increases from at least from when the sheet initially moves over said upstream edge.

4. The method according to claim 1, wherein the angle is greater than 10°.

5. The method according to claim 1, further comprising the step of applying a liquid on the treated sheet.

6. The method according to claim 1, further comprising the step of re-orienting the treated sheet, so that one of its edges is substantially parallel to a lateral direction perpendicular to a transport direction of the sheet.

7. The method according to claim 6, wherein the step of arranging comprises rotating the sheet upstream of the treatment unit, so that one of its edges is at a non-zero angle with the lateral direction.

8. The method according to claim 1, wherein the upstream edge of the at least one of the electrodes extends at the angle with respect to a lateral direction perpendicular to a transport direction of the sheet.

9. The method according to claim 8, wherein a leading edge of the sheet is substantially parallel to the lateral direction as it passes over the upstream edge of the at least one of the electrodes.

10. The method according to claim 1, wherein the gap is a substantially empty gap positioned at the upstream edge of the at least one of the electrodes, and the method further comprises a portion of the sheet first passing over the gap before reaching said electrode.

11. A printer comprising a plasma treatment unit with:
a pair of spaced apart electrodes for generating a plasma between them; and
a transport mechanism comprising:
a support structure spaced apart from one of the electrodes by a gap;
a suction arrangement for applying a negative pressure for drawing a sheet against at least the support structure; and
a drive for transporting the sheet in a transport direction over the support structure, over the gap, and over the one of the electrodes,
wherein the printer is configured, so that the drive transports the sheet over the one of the electrodes at an angle greater than 5° of a forward facing edge of the sheet with respect to an upstream edge of the one of the electrodes.

12. The printer according to claim 11, further comprising at least one registration drive of a registration unit for adjusting an orientation of the sheet with respect to the transport direction, wherein the at least one registration drive is configured for:
orienting the sheet, so that its forward facing edge is at the non-zero angle with respect to the upstream edge of the one of the electrodes when passing between the electrodes; and
orienting the sheet, so that its forward facing edge is substantially perpendicular to the transport direction.

13. The printer according to claim 12, wherein the at least one registration drive is configured for orienting the sheet, so that its leading edge is substantially perpendicular to the transport direction, is performed:
upstream of a printing assembly, so that the leading edge of the sheet is substantially parallel to a direction wherein the printing assembly extends; and/or
upstream of an output location, so that the sheet is positioned at the output location with its leading edge substantially perpendicular to the transport direction.

14. The printer according to claim 12, wherein the upstream edge of the one of the electrodes is substantially perpendicular to the transport direction, and at least one registration drive of a registration unit is configured to re-orient the sheet, so that its edge is at the non-zero angle with respect to the upstream edge of the one of the electrodes when passing between the electrodes.

15. The printer according to claim 11, wherein the upstream edge of the one of the electrodes is positioned substantially at the angle greater than 5° with respect to a lateral direction perpendicular to the transport direction, so that a forward facing edge of the sheet when parallel to the lateral direction passes over said upstream edge substantially at an angle therewith.

16. The printer according to claim 15, further comprising at least one registration drive of a registration unit for adjusting an orientation of the sheet with respect to the transport direction, wherein the at least one registration drive is configured for orienting a leading edge of the sheet, so that the leading edge of the sheet is substantially parallel to the lateral direction as the leading edge of the sheet passes over the upstream edge of the at least one of the electrodes.

17. The printer according to claim 11, wherein the angle is greater than 10°.

18. The method according to claim 1, further comprising the step of applying a liquid on the treated sheet, wherein a coating liquid is applied directly on the treated sheet, followed by the application of color inks on the coating liquid, wherein the coating liquid is a primer liquid.
